(19) United States
(12) Patent Application Publication
(10) Pub. No.: US 2026/0019892 A1
(43) Pub. Date: Jan. 15, 2026

(54) METHOD AND APPARATUS FOR CONDITIONAL HANDOVER IN WIRELESS COMMUNICATION SYSTEM

(71) Applicant: SAMSUNG ELECTRONICS CO., LTD., Suwon-si, Gyeonggi-do (KR)

(72) Inventors: Dingye ZHANG, Beijing (CN); Hong WANG, Beijing (CN); Yu PAN, Beijing (CN)

(21) Appl. No.: 18/994,561

(22) PCT Filed: Jul. 6, 2023
(86) PCT No.: PCT/KR2023/009606

§ 371 Date: Jan. 14, 2025

(30) Foreign Application Priority Data
Jul. 15, 2022 (CN) 202210837728.4

(51) Int. Cl. H04W 36/00; H04W 36/08

(52) U.S. Cl. CPC H04W 36/0069; H04W 36/08

(57) ABSTRACT

The disclosure relates to a 5G or 6G communication system for supporting a higher data transmission rate. A conditional handover method performed by a user equipment (UE) in a communication system may include: determining a configuration type of RRC configuration corresponding to a candidate target master node and a candidate target secondary node, performing a conditional handover operation according to the configuration type of the RRC configuration corresponding to the candidate target master node and the candidate target secondary node.

### TECHNICAL FIELD

The application relates to a field of communication. More particularly, the disclosure relates to a conditional handover method performed by a user equipment, a conditional handover method performed by a base station, a user equipment, a base station and a computer readable storage medium in a communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), Al service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

This disclosure relates to wireless communication networks, and more particularly to a terminal and a communication method thereof in a wireless communication system.

In accordance with an aspect of the disclosure, there is provided a conditional handover method performed by a source master node in a communication system, the method may include transmitting a first message to at least one candidate target master node respectively; receiving, from the candidate target master node, a second message that responds to the first message, wherein the second message includes information of an RRC configuration indication corresponding to the candidate target master node and a candidate target secondary node; and transmitting a third message including the information of the RRC configuration indication to a source secondary node.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

In order to more clearly and easily illustrate and understand the technical solutions in the embodiments of the application, the following is a brief description of the accompanying drawings that need to be used in the description of the embodiments of the application.

FIG. 1 is an exemplary system architecture of system architecture evolution;

FIG. 2 is an exemplary system architecture according to various embodiments of the disclosure;

FIG. 3A illustrates an example user equipment according to various embodiments of the application;

FIG. 3B illustrates an example base station according to various embodiments of the application;

FIG. 4 illustrates a flowchart of a conditional handover method performed by a user equipment in a communication system provided by an embodiment of the application;

FIG. 5 illustrates a flowchart of a conditional handover method performed by a source master node in a communication system provided by an embodiment of the application;

FIG. 6 illustrates a flowchart of a conditional handover method performed by a source secondary node in a communication system provided by an embodiment of the application;

FIG. 7 is a flowchart of a UE performing conditional handover in a dual connectivity state according to an embodiment of the disclosure;

FIG. 8 is a flowchart of a UE performing conditional handover in a dual connectivity state according to another embodiment of the disclosure;

FIG. 9 is a flowchart of a UE performing conditional handover in a dual connectivity state according to an embodiment of the disclosure;

FIG. 10 is a flowchart of a UE performing conditional handover in a dual connectivity state according to another embodiment of the disclosure;

FIG. 11 illustrates a block diagram of a user equipment in a communication system provided by an embodiment of the application; and

FIG. 12 illustrates a block diagram of a node device in a communication system provided by an embodiment of the application.

Throughout the drawings, it should be noted that like reference numbers are used to depict the same or similar elements, features, and structures.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

The purpose of the application aims to at least solve one of the technical defects in the existing communication methods to better meet the communication needs. In order to achieve this purpose, the technical solutions proposed in the application are as follows.

According to a first aspect of the embodiments of the disclosure, there is provided a conditional handover method performed by a source master node in a communication system, the method may include transmitting a first message to at least one candidate target master node respectively; receiving, from the candidate target master node, a second message that responds to the first message, wherein the second message includes information of an RRC configuration indication corresponding to the candidate target master node and a candidate target secondary node; and transmitting a third message including the information of the RRC configuration indication to a source secondary node.

As an implementation, the method may include receiving a fourth message from the source secondary node in a case where a secondary cell group configuration on the source secondary node is changed and there is at least one first configuration type or there is no second configuration type in the RRC configuration indication, wherein the fourth message includes indication information indicating that the secondary cell group configuration has been updated; and transmitting a conditional handover cancel message to at least one candidate target master node, and/or transmitting an alert message to a UE for notifying that conditional handover has been cancelled.

As an implementation, the method may include receiving a fourth message from the source secondary node in a case where a secondary cell group configuration on the source secondary node is changed and there is at least one first configuration type or there is no second configuration type in the RRC configuration indication, wherein the fourth message includes indication information indicating that the secondary cell group configuration has been updated; and transmitting a handover request message to at least one candidate target master node to update an RRC configuration of a UE.

As an implementation, the method may include receiving a fifth message from a UE in a case where a secondary cell group configuration on the source secondary node is changed and there is at least one first configuration type or there is no second configuration type in the RRC configuration indication, wherein the fifth message includes indication information indicating that the secondary cell group configuration has been updated and/or alert information indicating that an RRC configuration prepared for conditional handover has been deleted by the UE; and transmitting a conditional handover cancel message to at least one candidate target master node.

As an implementation, the transmitting the conditional handover cancel message to the at least one candidate target master node may include transmitting the conditional handover cancel message to each candidate target master node; or transmitting the conditional handover cancel message to a candidate target master node corresponding to an RRC configuration of the first configuration type.

As an implementation, the method may include receiving a fifth message from a UE in a case where a secondary cell group configuration on the source secondary node is changed and there is at least one first configuration type or there is no second configuration type in the RRC configuration indication, wherein the fifth message includes indication information indicating that the secondary cell group configuration has been updated and/or alert information indicating that an RRC configuration prepared for conditional handover has been deleted by the UE; and transmitting a handover request message to at least one candidate target master node to update an RRC configuration of the UE.

As an implementation, the transmitting the handover request message to the at least one candidate target master node may include transmitting the handover request message to a candidate target master node corresponding to an RRC configuration of the first configuration type.

As an implementation, the first configuration type is an RRC delta configuration type and the second configuration type is an RRC full configuration type.

According to a second aspect of the embodiments of the disclosure, there is provided a conditional handover method performed by a source secondary node in a communication system, the method may include receiving a third message from a source master node, wherein the third message includes information of an RRC configuration indication corresponding to a candidate target master node and a candidate target secondary node.

As an implementation, the method may include maintaining a secondary cell group configuration on the source secondary node unchanged in a case where there is at least one first configuration type or there is no second configuration type in the RRC configuration indication.

As an implementation, the first configuration type is an RRC delta configuration type and the second configuration type is an RRC full configuration type.

According to a third aspect of the embodiments of the disclosure, there is provided a conditional handover method performed by a user equipment (UE) in a communication system, the method may include determining a configuration type of an RRC configuration corresponding to a candidate target master node and a candidate target secondary node; and performing a conditional handover operation according to the configuration type of the RRC configuration corresponding to the candidate target master node and the candidate target secondary node.

As an implementation, the performing the conditional handover operation according to the configuration type of the RRC configuration corresponding to the candidate target master node and the candidate target secondary node may include deleting an RRC configuration prepared for conditional handover in a case where a secondary cell group configuration on a source secondary node is changed and there is at least one first configuration type or no second configuration type in the configuration type; and transmitting a fifth message to a source master node, wherein the fifth message includes indication information indicating that the secondary cell group configuration has been updated and/or alert information indicating that the RRC configuration prepared for conditional handover has been deleted by the UE.

As an implementation, the performing the conditional handover operation according to the configuration type of the RRC configuration corresponding to the candidate target master node and the candidate target secondary node may include storing a secondary cell group configuration on the source secondary node before change of the secondary cell group configuration in a case where the secondary cell group configuration is changed and there is at least one first configuration type or there is no second configuration type in the configuration type; and performing the conditional handover operation based on the stored secondary cell group configuration.

As an implementation, the performing the conditional handover operation according to the configuration type of the RRC configuration corresponding to the candidate target master node and the candidate target secondary node may include performing the conditional handover operation based on an RRC configuration of at least one second configuration type in a case where there is the at least one second configuration type in the configuration type.

As an implementation, the performing the conditional handover operation based on the RRC configuration of the at least one second configuration type may include performing the conditional handover operation based only on the second configuration type in the configuration type in a case where there is at least one first configuration type in the configuration type and a secondary cell group configuration on the source secondary node is changed; and notifying a source master node that the secondary cell group configuration is changed.

As an implementation, the method may include deleting all RRC configurations of the first configuration type saved by the UE.

As an implementation, the first configuration type is an RRC delta configuration type and the second configuration type is an RRC full configuration type.

According to a fourth aspect of the embodiments of the disclosure, there is provided a user equipment, the user equipment may include a transceiver; and a processor coupled to the transceiver and configured to perform the above conditional handover method performed by a user equipment.

According to a fifth aspect of the embodiments of the disclosure, there is provided a node device, the node device may include a transceiver; and a processor, coupled to the transceiver and configured to perform the above conditional handover method performed by a source master node or a source secondary node.

According to a sixth aspect of the embodiments of the disclosure, there is provided an electronic device, including at least one processor; and at least one memory storing computer-executable instructions, wherein the computer-executable instructions, when run by the at least one processor, cause the at least one processor to perform any one of the methods as described above.

According to a seventh aspect of embodiments of the disclosure, there is provided a computer-readable storage medium storing instructions, the instructions, when run by at least one processor, cause the at least one processor to perform the above conditional handover method.

The technical solutions provided by the embodiments of the disclosure brings at least the following beneficial effect: when a terminal device is in a dual connectivity state, the probability of radio resource control configuration connection failure when the terminal device accesses a target node is reduced, so as to improve the user's service experience.

The beneficial effects brought by the technical solutions provided by the embodiments of the application will be described later in connection with specific optional embodiments, or may be known from the description of the embodiments, or may be learned from the implementation of the embodiments.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to their bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the application can be applied to future-oriented communication technologies. In addition, the technical schemes of the embodiments of the application can be applied to future-oriented communication technologies.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

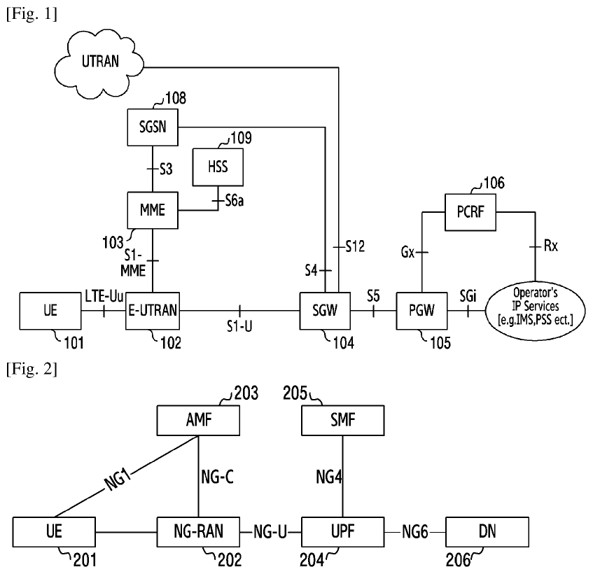

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

FIG. 2 is an exemplary system architecture 200 according to various embodiments of the disclosure. Other embodiments of the system architecture 200 can be used without departing from the scope of the disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

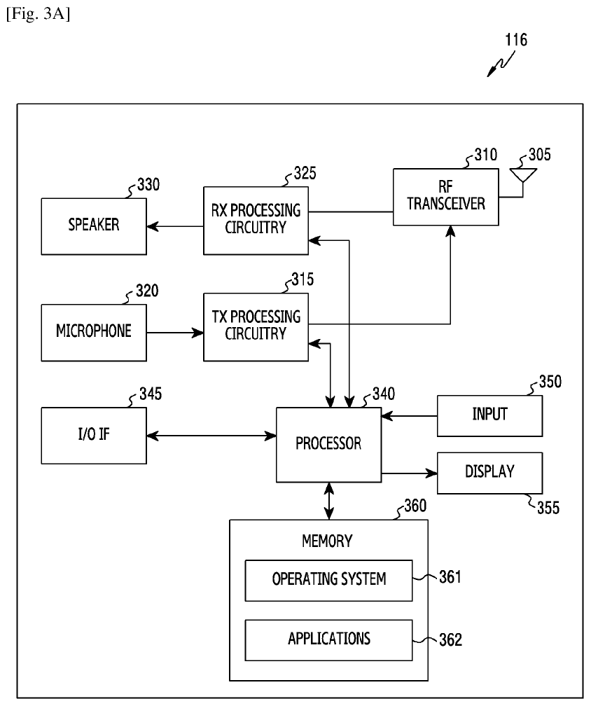

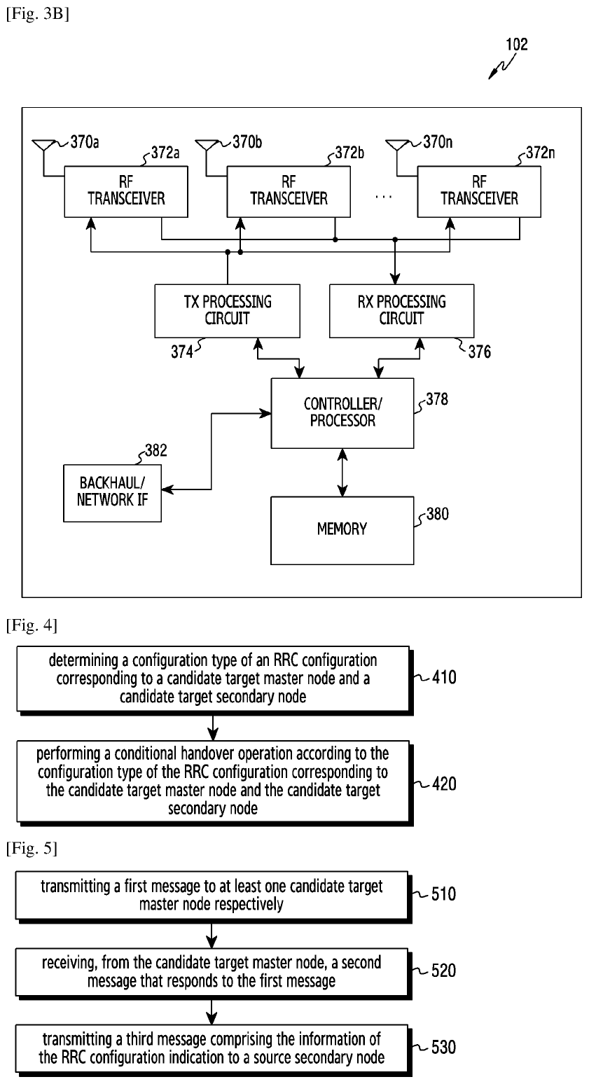

FIG. 3A illustrates an example UE 116 according to the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362. However, the components of the UE 116 are not limited thereto. For example, the UE 116 may include more or fewer components than those described above. In addition, the UE 116 corresponds to the UE of the FIG. 11.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

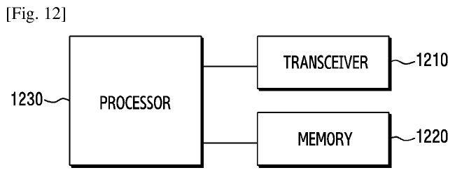

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382. However, the components of the gNB 102 are not limited thereto. For example, the gNB 102 may include more or fewer components than those described above. In addition, the gNB 102 corresponds to the base station of the FIG. 12.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

It is understood that the solutions provided by the embodiments of the application may be applicable to, but not limited to, the wireless network described above.

Detailed descriptions of steps not related to the invention are omitted from the application. In the following embodiments, a 5G system is taken as an example, a centralized unit in an access network is described as a CU, and a distribution unit is described as a DU. The described method may also be used for corresponding entities of other systems.

In the application, a node communicating with a UE may be a complete base station (e.g., gNB, or eNB, or en-gNB, or ng-eNB), or a base station including the centralized unit and the distribution unit, or a base station including a control plane portion of the centralized unit (Central Unit Control Plane, CU-CP), a user plane portion of the centralized unit (Central Unit-User Plane, CU-UP) and the distribution unit.

In the application, the message names are examples only and other names may be used to name the messages. The sequence numbers of the messages do not represent the order in which the messages are executed, but only the names of the messages.

Dual Connectivity (DC) was introduced in the New Radio Access (NRA) network version-Release 15 to improve network performance and service volume for a single user, and the performance of the technology is being continuously improved in the studies of R16 and R17.

In the dual connectivity, the UE is connected to two nodes, one of which acts as a Master Node (MN) and the other one acts as a Secondary Node (SN). A set of cells serving the UE in the MN is called as Master Cell Group (MCG) and a set of cells serving the UE in the SN is called as Secondary Cell Group (SCG). A master cell on the MCG is called as PCell and a master cell (SpCell) on the SCG is called as PSCell.

A Conditional Handover (CHO) technology is introduced in R16 to improve the reliability and robustness of PCell change. The MN may pre-configure multiple candidate MCG master cell PCells and CHO execution conditions for the UE. When at least one candidate PCell satisfies the execution conditions and after the UE completes the PCell change process, both the network and the UE will stop using the CHO mechanism and also release the configuration information of the candidate PCell and the CHO execution conditions. To start the CHO process, the network needs to send a configuration message to the UE to re-trigger the CHO mechanism and provide information indicating the candidate PCell and the CHO execution conditions, etc.

In R17, CHO supports the user equipment switching from a dual connectivity state to a dual connectivity state or a single-base station connectivity state, and also supports the user equipment switching from a single-base station connectivity state to a dual connectivity state. The network configures conditional handover for a user equipment (UE) in a dual connectivity state. One or more handover conditions are included in a handover command. When at least one of the handover conditions is satisfied, the user equipment performs random access on a target master cell group (MCG) and a target secondary cell group (SCG), establishes a wireless connection from the UE to a master cell (PCell) on the target MCG and a master cell (PSCell) on the target SCG, and completes the handover in the dual connectivity state. A radio resource control configuration used by the UE when accessing to a target cell is configured by a target node and sent to the UE via a source node.

An RRC configuration message configured by the target node has two state indications: a full configuration (full config) message and a delta configuration (delta config) message. In order to save valuable radio transmission resources, the radio resource configuration message often used by the network equipment node is the delta configuration message (delta config). When the UE uses the delta configuration message, the UE will configure the delta message based on the currently used radio resource control message to complete the access and radio resource control connection to the target base station.

The UE in the dual connection state, after receiving the conditional handhover configuration message from the network, saves the radio resource control configuration message sent by the target network node and starts evaluating the handover condition. When the handover condition is not satisfied, the UE still maintains the wireless connection with the source master node (Source MN, S-MN) and the source secondary node (Source SN, S-SN). The source secondary node (S-SN) may instruct the UE to perform cell switching and complete the PSCell change depending on the radio channel state of the UE on the PSCell. In existing schemes, this PSCell change does not necessarily need to be notified to the source master node. At this point, if the trigger condition for conditional handover is satisfied, the UE performs random access on the target master cell group (MCG) and the target secondary cell group (SCG) to try to establish a wireless connection from the UE to the master cell (PCell) on the target MCG and the master cell (PSCell) on the target SCG.

If the RRC configuration message configured for the target cell is the delta configuration message (delta config), the UE will configure the delta message based on the currently used radio resource control configuration message. The delta configuration of the RRC configuration configured for the target cell is required to be configured based on the radio resource control configuration message used by the UE when it receives the conditional handover configuration message. This may possibly leads to failure for the UE when accessing to the target cell, resulting in the failure of accessing to the wireless link and thus affecting the user's service experience.

Therefore, the disclosure proposes a method of performing conditional handover by a terminal device (UE) and a network device while the terminal is in a dual connectivity state, in which for the state indication of the RRC configuration in the above problem, control messages are transmitted between network nodes and between the nodes and the UE, and the UE performs corresponding operations based on the control messages, thereby reducing the probability of the radio resource control configuration connection failure when the UE accesses the target node, thereby improving the user's service experience.

In the disclosure, in CHO, a source base station may also be referred to as a source node. A candidate target base station may be referred to as a candidate target node. During the handover process, a new base station selected by the UE may be referred to as a target base station or a target node.

In the handover process under dual connectivity, a master base station (MN) may be referred to as a master node. A secondary base station (SN) may be referred to as a secondary node. A candidate target secondary base station (T-SN) may be referred to as a candidate target secondary node. When the secondary base station is updated, a new secondary base station may be referred to as a target secondary base station or a target secondary node.

The technical solutions of the application and how the technical solutions of the application solve the above technical problem are described in detail below in specific embodiments. The following specific embodiments may be combined with each other, and the same or similar concepts or processes may not be repeated in some embodiments. The exemplary embodiments of the application are described below in conjunction with the accompanying drawings. The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

The disclosure may solve the problem that the radio resource control configuration connection fails due to the change of the secondary cell group configuration when the user equipment (UE) performs conditional handover in the dual connectivity state. The method of performing conditional handover by the terminal and the network device when the terminal is in the dual connectivity state may include the transmission of control information between the network nodes, the transmission between the network node and the terminal device (such as UE), and a method for the terminal device to operate according to the control information.

FIG. 4 illustrates a flowchart of a conditional handover method performed by a user equipment in a communication system provided by an embodiment of the application. The method shown in FIG. 4 is mainly used to address how the UE implements conditional handover in a dual connectivity state.

As shown in FIG. 4, at step 410, a configuration type of an RRC configuration corresponding to a candidate target master node and a candidate target secondary node is determined.

When the UE performs conditional handover in the dual connectivity state, the UE receives a radio resource control (RRC) reconfiguration message from a source master node. The RRC reconfiguration message includes RRC configuration information. The RRC configuration information refers to RRC configuration information used by the UE to access to the candidate target master node and the candidate target secondary node when a condition of the conditional handover is satisfied.

For example, in LTE, the RRC reconfiguration message may refer to RRCConnectionReconfiguraiton, and in NR, the RRC reconfiguration message may refer to RRCReconfiguration.

When the UE is in a dual connectivity state with the source master node and a source secondary node, the source master node may send a handover request message to multiple candidate target master nodes when the source master node decides to use the conditional handover. When one candidate target master node receives the handover request message, this candidate target master node sends a secondary node addition request to a candidate target secondary node. For each candidate target master node, the candidate target master node may send the secondary node addition request to a corresponding candidate target secondary node. The candidate target secondary node sends a secondary node addition request acknowledgement message to the corresponding candidate target master node. At this point, the secondary node addition request acknowledgement message may include RRC configuration information of the candidate target secondary node and a type of the RRC configuration information. After the candidate target master node receives the corresponding secondary node addition request acknowledgement message, RRC configuration information of the candidate target master node is generated. Next, for each candidate target master node, the candidate target master node sends a handover request acknowledgement message to the source master node. At this point, the handover request acknowledgement message may include the RRC configuration information of the corresponding candidate target master node and the RRC configuration information of the corresponding candidate target secondary node.

The source master node may receive the corresponding RRC configuration information, including the RRC configuration information of the candidate target master node and the corresponding candidate target secondary node, from each candidate target master node.

Next, the source master node may send the radio resource control (RRC) reconfiguration message, which may also be referred to as a conditional handover configuration message, to the UE.

The RRC reconfiguration message may include the RRC configuration information corresponding to at least one pair of candidate target master node and candidate target secondary node as well as at least one handover condition. In addition, the at least one handover condition is generated by the source master node.

After the UE receives the RRC reconfiguration message from the source master node, it may determine a configuration type of each RRC configuration based on the RRC configuration in the RRC reconfiguration message. For example, the UE may determine the RRC configuration to be a delta configuration type or a full configuration type. The above examples are only exemplary and the disclosure is not limited thereto.

At step 420, a conditional handover operation is performed according to the configuration type of the RRC configuration corresponding to the candidate target master node and the candidate target secondary node.

The UE in the dual connectivity state, upon receiving the RRC reconfiguration message (i.e., the conditional handover configuration message) from the source master node, may save the radio resource control configuration message sent by the candidate target network node and starts evaluating the handover condition. When the handover condition is not satisfied, the UE still maintains the wireless connection with the source master node and the source secondary node. The source secondary node may instruct the UE to perform PSCell change or radio resource control configuration update to complete change of a secondary cell group configuration based on a radio channel state of the UE on the secondary cell group configuration.

In a case where the secondary cell group configuration on the source secondary node is changed and there is at least one first configuration type or there is no second configuration type in the configuration type, the UE may delete an RRC configuration prepared for conditional handover and send a fifth message to the source master node. For example, the fifth message may include indication information indicating that the secondary cell group configuration has been updated and/or alert information indicating that the RRC configuration prepared for conditional handover has been deleted by the UE.

As an example, the UE may delete/cancel the RRC configuration prepared for conditional handover if the secondary cell group configuration on the source secondary node is changed and there is at least one first configuration type or there is no second configuration type in the configuration type. The UE may then send a UE assistance information message to the source master node. The UE assistance information message may include indication information indicating that the secondary cell group configuration on the source secondary node has been updated and/or alert information indicating that the RRC configuration prepared for conditional handover has been deleted by the UE.

For example, since the delta configuration is that delta messages need to be configured based on the RRC configuration message used when the UE received the RRC reconfiguration message, if the secondary cell group configuration on the source secondary node is changed and there is at least one delta configuration type or there is no full configuration type in the RRC configuration type received by the UE, the UE may delete the RRC configuration prepared for conditional handover and send the UE assistance information message to the source master node. After the source master node knows that the UE has deleted the RRC configuration for conditional handover, the source master node may send a conditional handover cancel message to all candidate target master nodes to release relevant network resources. Alternatively, when the source master node knows that the UE has deleted the RRC configuration for conditional handover, the source master node may send the conditional handover cancel message to the candidate target master node corresponding to the delta configuration to release relevant network resources.

According to another embodiment, the UE may cancel/delete the RRC configuration prepared for conditional handover if the secondary cell group configuration on the source secondary node is changed and there is at least one first configuration type or there is no second configuration type in the configuration type. The UE may then send the UE assistance information message to the source master node. The UE assistance information message may include indication information indicating that the secondary cell group configuration on the source secondary node has been updated and/or alert information indicating that the RRC configuration prepared for conditional handover has been deleted by the UE. After the source master node knows that the RRC configuration for conditional handover has been deleted by the UE, the source master node may send a handover request message to all candidate target master nodes to obtain a new RRC configuration for conditional handover.

According to another example of the disclosure, in a case where the secondary cell group configuration on the source secondary node is changed and there is at least one first configuration type or there is no second configuration type in the configuration type, the UE may store the secondary cell group configuration before the change of the secondary cell group configuration, and perform the conditional handover operation based on the stored secondary cell group configuration.

For example, if the secondary cell group configuration on the source secondary node is changed and there is at least one first configuration type or there is no second configuration type in the configuration type, the UE may store the secondary cell group configuration on the source secondary node before the secondary cell group configuration is changed, such that the UE may perform the conditional handover operation based on the secondary cell group configuration before the change.

As an example, since delta configuration is that delta messages need to be configured based on the RRC configuration message used when the UE received the RRC reconfiguration message, if the secondary cell group configuration on the source secondary node is changed and there is at least one delta configuration type or there is no full configuration type in the RRC configuration type received by the UE, the UE may store the previous RRC configuration during the RRC reconfiguration performed by the source secondary node, such that the UE may use the RRC configuration before the change and the delta configuration message to complete the conditional handover when the handover condition is satisfied.

In a case where there is at least one second configuration type among the determined configuration type, the UE may perform the conditional handover operation based on an RRC configuration of the at least one second configuration type.

For example, if there is at least one second configuration type in the configuration type received by the UE, the UE may perform the conditional handover operation based on the RRC configuration of the at least one second configuration type. For example, since the full configuration does not have the problem of the delta configuration as described above, if the RRC configuration of at least one pair of candidate target master and secondary nodes among the configuration type received by the UE is the full configuration, the UE may then perform the conditional handover in the RRC configuration of the full configuration type.

In a case where there is at least one first configuration type in the determined configuration type and the secondary cell group configuration on the source secondary node is changed, the UE may perform the conditional handover operation based only on the RRC configuration of the second configuration type among the configuration type, and notify the source master node that the secondary cell group configuration has been changed. In addition, the UE may also delete all RRC configurations of the first configuration type saved by the UE.

As an example, if there is a delta configuration type along with at least one full configuration type among the RRC configuration type saved by the UE, the UE may delete all saved RRC configurations of the first configuration type and perform the conditional handover operation based on the RRC configuration of the at least one second configuration type when the secondary cell group configuration on the source secondary node is changed.

As another example, if there is a delta configuration type along with at least one full configuration type among the configuration type saved by the UE, when the secondary cell group configuration on the source secondary node is changed, the UE may not evaluate the conditional handover condition corresponding to the delta configuration type, but only evaluate the conditional handover condition corresponding to the full configuration type and notify the network that the secondary cell group configuration has been changed and that the UE currently monitors only the conditional handover condition corresponding to the full configuration type.

For example, when there is a delta configuration along with at least one full configuration among the RRC configuration saved by the UE, after the SCG configuration is changed, the UE may delete all saved delta configurations or the UE may no longer evaluate the conditional handover condition corresponding to the delta configuration, but only monitor the conditional handover condition corresponding to the full configuration, and notify the network that the SCG configuration has been changed and that the UE currently monitors only the conditional handover condition of the full configuration.

FIG. 5 illustrates a flowchart of a conditional handover method performed by a source master node in a communication system provided by an embodiment of the application.

Referring to FIG. 5, at step 510, a first message is sent to at least one candidate target master node, respectively. For example, the first message may refer to a handover request message. At step 520, a second message in response to the first message may be received from the candidate target master node, wherein the second message may include information of an RRC configuration indication corresponding to the candidate target master node and a candidate target secondary node. For example, the second message may refer to a handover request acknowledgement message.

When the UE is in a dual connectivity state with the source master node and a source secondary node, the source master node may send a handover request message to multiple candidate target master nodes when the source master node decides to use the conditional handover. When a candidate target master node receives the handover request message, this candidate target master node sends a secondary node addition request message to a candidate target secondary node. For each candidate target master node, the candidate target master node may send the secondary node addition request message to a corresponding candidate target secondary node. The candidate target secondary node sends a secondary node addition request acknowledgement message to the corresponding candidate target master node. At this point, the secondary node addition request acknowledgement message may include RRC configuration information of the candidate target secondary node and a type of the RRC configuration information. After the candidate target master node receives the corresponding secondary node addition request acknowledgement message, the RRC configuration information of the candidate target master node is generated. Next, for each candidate target master node, the candidate target master node sends the handover request acknowledgement message to the source master node. At this point, the handover request acknowledgement message may include the RRC configuration information of the corresponding candidate target master node and the RRC configuration information of the corresponding candidate target secondary node.

According to the embodiment of the disclosure, the handover request acknowledgment message may also include information for indicating an RRC configuration type indication corresponding to the corresponding candidate target master node and candidate target secondary node. For example, a candidate target master node may send, to the source master node, the handover request acknowledgment message including RRC configuration information for the candidate target master node, RRC configuration information for the corresponding candidate target secondary node, and configuration type of the RRC configuration information.

The source master node may receive the corresponding handover request acknowledgement message from each candidate target master node.

Next, the source master node may send a radio resource control (RRC) reconfiguration message, which may also be referred to as a conditional handover configuration message, to the UE. The RRC reconfiguration message may include RRC configuration information corresponding to at least one pair of candidate target master node and candidate target secondary node. Here, the RRC configuration information refers to RRC configuration information used by the UE to access to the candidate target master node and the candidate target secondary node when a condition of the conditional handover is satisfied.

For example, in LTE, the RRC reconfiguration message may refer to RRCConnectionReconfiguraiton, and in NR, the RRC reconfiguration message may refer to RRCReconfiguration.

The RRC reconfiguration message may include RRC configuration information corresponding to at least one pair of candidate target master node and candidate target secondary node as well as at least one handover condition. In addition, the at least one handover condition is generated by the source master node.

At step 530, a third message including the information of the RRC configuration indication is sent to the source secondary node.

During the handover condition evaluation process or after the UE sends an RRC connection configuration complete message to the source master node, the source master node may send the third message including the information of the RRC configuration indication, which may also be referred to as indication information, to the source secondary node to inform the source secondary node of a configuration type of an RRC configuration which is prepared by the UE for the conditional handover. The third message may be implemented as an inter-network node user-plane address indication message (Xn-U Address Indication message) or as a new message.

For example, the indication information may be provided in the inter-network node user-plane address indication message (Xn-U Address Indication message), and the indication information for indicating the type of the RRC configuration (i.e., the information of the RRC configuration indication) may be sent together when the source master node sends the inter-network node user-plane address indication message (Xn-U Address Indication message) to the source secondary node.

For another example, a new message may be used to transmit the information of the RRC configuration indication.

According to the embodiment of the disclosure, upon receiving the RRC reconfiguration message by the UE, the configuration type of the received RRC configuration may be determined and the information of the RRC configuration indication may be sent together when the RRC configuration connection complete message is sent to the source master node. Alternatively, after the source master node receives the handover request acknowledgment message from each candidate target master node, the configuration type of the RRC configuration may be determined, and the information of the RRC configuration indication may be sent to the source secondary node through the inter-network node user-plane address indication message (Xn-U Address Indication message) or a new message.

The above examples are only exemplary and the disclosure is not limited thereto.

Next, the source master node may perform a conditional handover operation based on the configuration type of the RRC configuration corresponding to the candidate target master node and the candidate target secondary node.

According to the embodiment, the source master node may receive a fourth message from the source secondary node in a case where a secondary cell group configuration on the source secondary node is changed and there is at least one first configuration type or there is no second configuration type in the RRC configuration indication. The fourth message may include indication information for indicating that the secondary cell group configuration has been updated, and then the source master node may send a conditional handover cancel message to at least one candidate target master node, and/or send an alert message to the UE for notifying that the conditional handover has been cancelled. The fourth message may be implemented as a secondary node modification required message or a new message.

After sending the message including the indication information to the source secondary node, the source master node may receive the secondary node modification required message from the source secondary node, if the secondary cell group configuration on the source secondary node is changed and there is at least one first configuration type or there is no second configuration type in the configuration type. The secondary node modification required message may include indication information indicating that the secondary cell group configuration on the source secondary node has been updated.

In response to the secondary node modification required message, the source master node may send the conditional handover cancel message to each candidate target master node, and/or send the alert message, which is used for notifying that the conditional handover has been cancelled, to the UE.

Alternatively, in response to the secondary node modification required message, the source master node may send the conditional handover cancel message to a candidate target master node corresponding to a delta configuration, and/or send the alert message, which is used for notifying that the conditional handover has been cancelled, to the UE.

For example, when the secondary cell group configuration on the source secondary node is changed and there is at least one delta configuration type or there is no full configuration type in the RRC configuration, the source secondary node may send, to the source master node, the secondary node modification required message for the secondary cell group configuration change. The source master node may then send the conditional handover cancel message to each candidate target master node, causing relevant network resources to be released, and send the alert message, which is used for notifying that the conditional handover has been cancelled, to the UE, enabling the UE to cancel the RRC configuration that has been prepared for the conditional handover. Alternatively, the source master node may send the conditional handover cancel message to the candidate target master node corresponding to the delta configuration, and/or send the alert message, which is used for notifying that the conditional handover has been cancelled to the UE.

According to another embodiment, a new message is received from the source secondary node if the secondary cell group configuration on the source secondary node is changed and there is at least one first configuration type or there is no second configuration type in the RRC configuration type, wherein the new message includes indication information indicating that the secondary cell group configuration has been updated. In response to the new message, the source master node may send the conditional handover cancel message to each candidate target master node and send the alert message for notifying that the conditional handover has been cancelled to the UE. Alternatively, the source master node may send the conditional handover cancel message to the candidate target master node corresponding to the delta configuration and/or send the alert message for notifying that the conditional toggle has been cancelled to the UE.

For example, if the secondary cell group configuration on the source secondary node is changed and there is at least one delta configuration type or there is no full configuration type in the RRC configuration type, after the source secondary node notifies the source master node that the secondary cell group configuration is updated via a new message (e.g. a Class 2 message), the source master node may send the conditional handover cancel message to each candidate target master node, and send the alert message, which is used for notifying that the conditional handover has been cancelled, to the UE. In the case of using the new message, the source master node does not need to respond with a reply to the source secondary node.

According to another embodiment of the disclosure, after sending the message including the indication information to the source secondary node, if the secondary cell group configuration on the source secondary node is changed and there is at least one first configuration type or there is no second configuration type in the configuration type, the source master node may receive a secondary node modification required message from the source secondary node, wherein the secondary node modification required message includes indication information indicating that the secondary cell group configuration has been updated. In response to the secondary node modification required message, the source master node may send the handover request message to each candidate target master node to update the RRC configuration of the UE. Alternatively, the source master node may send the handover request message to the candidate target master node corresponding to the RRC configuration of the delta configuration to update the RRC configuration of the UE.

For example, the source secondary node may send, to the source master node, the secondary node modification required message for the secondary cell group configuration change, when the secondary cell group configuration on the source secondary node is changed and there is at least one delta configuration type or there is no full configuration type in the RRC configuration. Then, the source master node may send the handover request message to the candidate target master node corresponding to the delta configuration. In this way, the source master node may again receive the corresponding RRC configuration information from the candidate target master node corresponding to the delta configuration and then send it to the UE, causing the UE to configure new RRC configuration information.

According to another embodiment, if the secondary cell group configuration on the source secondary node is changed and there is at least one first configuration type or there is no second configuration type in the RRC configuration type, a new message is received from the source secondary node, wherein the new message includes indication information indicating that the secondary cell group configuration has been updated. In response to the new message, the source master node may send the handover request message to each candidate target master node or the candidate target node corresponding to the delta configuration.

For example, if the secondary cell group configuration on the source secondary node is changed and there is at least one delta configuration type or there is no full configuration type in the RRC configuration type, after the source secondary node notifies the source master node that the secondary cell group configuration is updated via a new message (such as a Class 2 message), the source master node may send the handover request message to the candidate target master node corresponding to the delta configuration again, to obtain new RRC configuration information for conditional handover. In the case of using the new message, the source master node does not need to respond with a reply to the source secondary node.

The purpose of the above operations is that the source master node may trigger the handover request again to obtain a new RRC configuration, considering that in the handover condition evaluation, the delta configuration information is not available if the secondary cell group configuration on the source secondary node is updated. During the handover condition evaluation, if the secondary cell group configuration on the source secondary node is changed, the source master node may send the handover request message again, to reduce the possibility of radio resource control configuration connection failure by the UE when accessing to the target node in the presence of the delta configuration.

According to yet another embodiment of the disclosure, after sending the message including the indication information to the source secondary node, if there is at least one first configuration type or there is no second configuration type in the configuration type, the source secondary node may keep the secondary cell group configuration on the source secondary node unchanged, such that when performing the conditional handover, the conditional handover operation may be performed based on the previous secondary cell group configuration.

For example, it is assumed that there is at least one delta configuration type or there is no full configuration type in the configuration type received by the UE, the source secondary node knows that there is at least one delta configuration type or no full configuration type exists after receiving the indication information, and during the handover condition evaluation, even if the source secondary node should instruct the UE to perform PSCell change based on a radio channel state of the UE on the PSCell, the source secondary node no longer instructs the UE to perform PSCell change at this time, but keeps the secondary cell group configuration on the source secondary node unchanged, so that the UE may perform conditional handover based on the previous cell configuration and the delta configuration information, avoiding the radio resource control configuration connection failure when the UE accesses to the target node in the presence of the delta configuration.

According to another embodiment of the disclosure, if the secondary cell group configuration on the source secondary node is changed and there is at least one first configuration type or there is no second configuration type in the configuration type, the UE may cancel the RRC configuration prepared for conditional handover, and send a UE assistance information message to the source master node. The UE assistance information message may include indication information indicating that the secondary cell group configuration on the source secondary node has been updated, and/or alert information indicating that the RRC configuration prepared for conditional handover has been cancelled by the UE. Thus the source master node, in response to the UE assistance information message, may send a handover cancel message to each candidate target master node after the source master node knows that the RRC configuration prepared for conditional handover has been cancelled by the UE, to release relevant network resources.

Before the source master node sends the radio resource control (RRC) reconfiguration message to the UE, for each candidate target master node, the candidate target master node may send a secondary node addition request message to the candidate target secondary node. In response to the secondary node addition request message, the candidate target secondary node may check whether a signaling connection (e.g. SRB3) exists between the UE and the source secondary node. If the signaling connection exists, the candidate target secondary node may determine that the configuration type corresponding to the candidate target secondary node is the full configuration type.

According to another embodiment of the disclosure, the source master node may receive a fifth message from the UE if the secondary cell group configuration on the source secondary node is changed and there is at least one first configuration type or there is no second configuration type in the RRC configuration indication. The fifth message may include indication information indicating that the secondary cell group configuration has been updated and/or alert information indicating that the RRC configuration prepared for conditional handover has been deleted by the UE, and then the source master node may send a conditional handover cancel message to at least one candidate target master node.

For example, if the secondary cell group configuration on the source secondary node is changed and there is at least one first configuration type or there is no second configuration type in the RRC configuration type, the source master node may receive the UE assistance information message from the UE, wherein the UE assistance information message may include indication information indicating that the secondary cell group configuration has been updated, and/or alert information indicating that the RRC configuration prepared for conditional handover has been cancelled by the UE. In response to the UE assistance information message, the source master node may send the handover request message to each candidate target master node again to update the current RRC configuration of the UE, or may send the conditional handover cancel message to the candidate target master node corresponding to the RRC configuration of the first configuration type.

The above examples are only exemplary and the disclosure is not limited thereto.

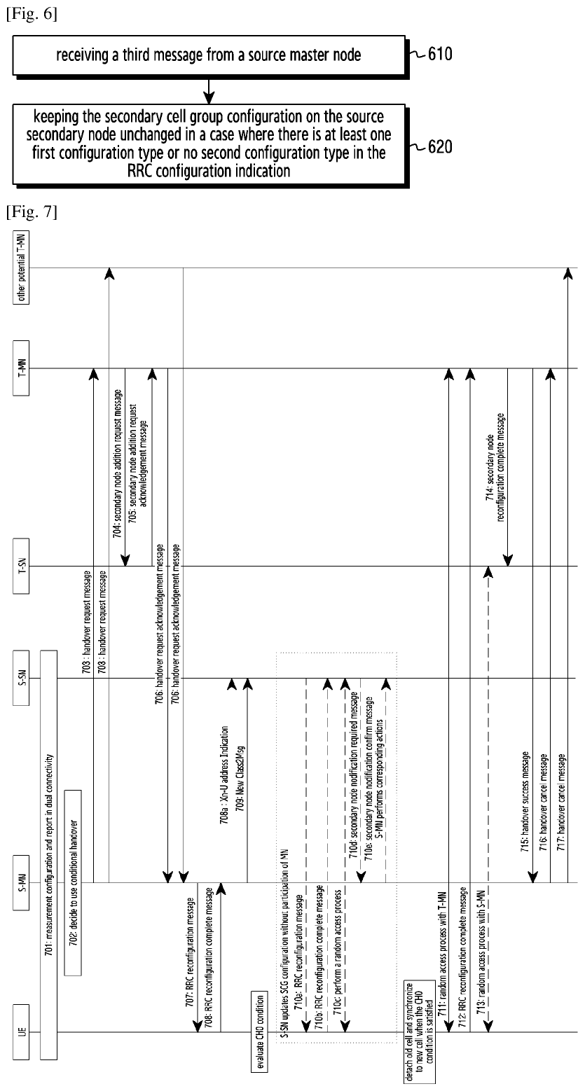

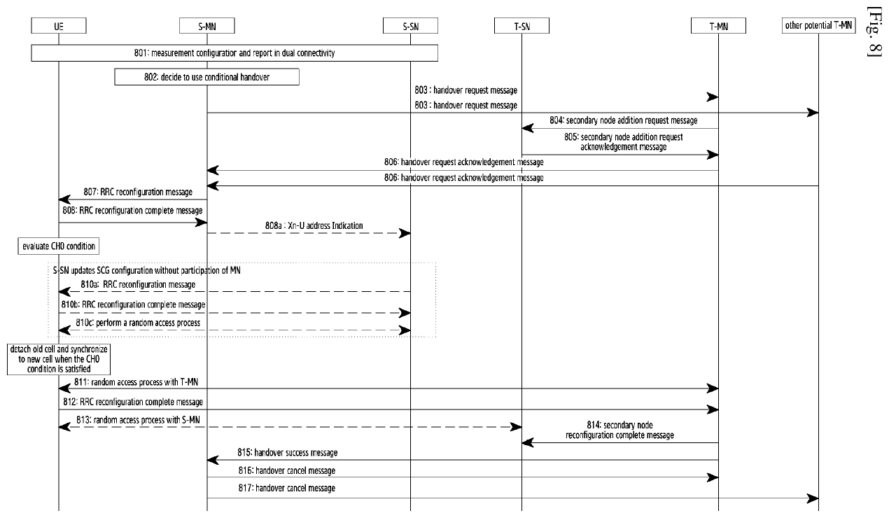

FIG. 6 illustrates a flowchart of a conditional handover method performed by a source secondary node in a communication system provided by an embodiment of the application.

Referring to FIG. 6, at step 610, a third message is received from a source master node. The third message may include information of an RRC configuration indication corresponding to a candidate target master node and a candidate target secondary node.

When a candidate target master node receives the handover request message, this candidate target master node sends a secondary node addition request message to a candidate target secondary node. For each candidate target master node, the candidate target master node may send the secondary node addition request message to a corresponding candidate target secondary node. The candidate target secondary node sends a secondary node addition request acknowledgement message to the corresponding candidate target master node. At this point, the secondary node addition request acknowledgement message may include RRC configuration information of the candidate target secondary node and a type of the RRC configuration information. After the candidate target master node receives the corresponding secondary node addition request acknowledgement message, the RRC configuration information of the candidate target master node is generated. Next, for each candidate target master node, the candidate target master node sends the handover request acknowledgement message to the source master node. At this point, the handover request acknowledgement message may include the RRC configuration information of the corresponding candidate target master node and the RRC configuration information of the corresponding candidate target secondary node.

According to the embodiment of the disclosure, the handover request acknowledgment message may also include information for indicating an RRC configuration type indication corresponding to the corresponding candidate target master node and candidate target secondary node. For example, one candidate target master node may send, to the source master node, the handover request acknowledgment message including RRC configuration information for the candidate target master node, RRC configuration information for the corresponding candidate target secondary node, and configuration types of the RRC configuration information.

The source master node may receive the corresponding handover request acknowledgement message from each candidate target master node.

Next, the source master node may send a radio resource control (RRC) reconfiguration message, which may also be referred to as a conditional handover configuration message, to the UE. The RRC reconfiguration message may include RRC configuration information corresponding to at least one pair of candidate target master node and candidate target secondary node. Here, the RRC configuration information refers to RRC configuration information used by the UE to access to the candidate target master node and the candidate target secondary node when a condition of the conditional handover is satisfied.

For example, in LTE, the RRC reconfiguration message may refer to RRCConnectionReconfiguraiton, and in NR, the RRC reconfiguration message may refer to RRCReconfiguration.

The RRC reconfiguration message may include RRC configuration information corresponding to at least one pair of candidate target master node and candidate target secondary node as well as at least one handover condition. In addition, the at least one handover condition is generated by the source master node.

The source master node may send a third message including the information of the RRC configuration indication to the source secondary node.

During the handover condition evaluation process or after the UE sends an RRC connection configuration complete message to the source master node, the source master node may send the third message including the information of the RRC configuration indication, which may also be referred to as indication information, to the source secondary node to inform the source secondary node of a configuration type of an RRC configuration that is prepared by the UE for the conditional handover. The third message may be implemented as an inter-network node user-plane address indication message (Xn-U Address Indication message) or as a new message.

For example, the indication information may be provided in the inter-network node user-plane address indication message (Xn-U Address Indication message), and the indication information for indicating the type of the RRC configuration (i.e., the information of the RRC configuration indication) may be sent together when the source master node sends the inter-network node user-plane address indication message (Xn-U Address Indication message) to the source secondary node.

For another example, a new message may be used to transmit the information of the RRC configuration indication.

According to the embodiment of the disclosure, upon receiving the RRC reconfiguration message by the UE, the configuration type of the received RRC configuration may be determined and the information of the RRC configuration indication may be sent together when the RRC configuration connection complete message is sent to the source master node. Alternatively, after the source master node receives the handover request acknowledgment message from each candidate target master node, the configuration type of the RRC configuration may be determined and the information of the RRC configuration indication may be sent to the source secondary node through the inter-network node user-plane address indication message (Xn-U Address Indication message) or a new message.

The above examples are only exemplary and the disclosure is not limited thereto.

At step 620, the secondary cell group configuration on the source secondary node is kept unchanged in a case where there is at least one first configuration type or there is no second configuration type in the RRC configuration indication.

After the source secondary node receives the message including the indication information, the source secondary node may keep the secondary cell group configuration on the source secondary node unchanged if there is at least one first configuration type or there is no second configuration type exists in the configuration type, such that the conditional handover operation may be performed based on the previous secondary cell group configuration when performing the conditional handover.

For example, it is assumed that there is at least one delta configuration type or there is no full configuration type in the configuration type received by the UE, the source secondary node knows that there is at least one delta configuration type or no full configuration type exists after receiving the indication information, and during the handover condition evaluation, even if the source secondary node should instruct the UE to perform PSCell change based on a radio channel state of the UE on the PSCell, the source secondary node no longer instructs the UE to perform PSCell change at this time, but keeps the secondary cell group configuration on the source secondary node unchanged, so that the UE may perform conditional handover based on the previous cell configuration and the delta configuration information, avoiding the radio resource control configuration connection failure when the UE accesses to the target node in the presence of the delta configuration.

FIG. 7 is a flowchart of a UE performing conditional handover in a dual connectivity state according to an embodiment of the disclosure. FIG. 7 depicts a method of transmitting relevant control information between network device nodes. The conditional handover in the dual connectivity state is described in detail below using a 5G system as an example.

At step 701, a source master node (S-MN) and a source secondary node (S-SN) perform an interaction process of measurement configuration and measurement report while the UE is in the dual connectivity state.

At step 702, the source master node decides to enable the UE to perform conditional handover while the UE is in the dual connectivity state. The source master node decides to use the conditional handover.

At step 703, the source master node sends a handover request message to a plurality of candidate target master nodes. The handover request message includes indication information for the conditional handover.

The handover request message may include, for example, a node identification of the UE at the source secondary node and a user identification of the user at the source secondary node, etc. Through this handover request message, the candidate target master nodes may know that this handover is initiated for the UE in the dual connectivity state and that a secondary node needs to be added for preparing target access resources.

At step 704, for each candidate target master node, the candidate target master node sends a secondary node addition request message to a candidate target secondary node. After one candidate target master node receives the handover request message, the candidate target master node sends the secondary node addition request message to a candidate target secondary node. The following is described as an example of a pair of candidate target master and secondary nodes (such as a target node to which the UE will be switched).

At step 705, the candidate target secondary node sends a secondary node addition request acknowledgement message to the candidate target master node. The secondary node addition request acknowledgement message may include indication information of a Radio Resource Control (RRC) configuration used by the corresponding candidate target secondary node when the UE accesses to the candidate target secondary node. The indication information may be used to indicate an RRC configuration type. A value of the indication information of the RRC configuration (RRC Config indication) may include, but not limited to, a delta configuration (delta config) and a full configuration (full config). For example, when the indication information has a first value, the RRC configuration type may be determined to be the delta configuration. When the indication information has a second value, the RRC configuration type may be determined to be the full configuration. The above examples are exemplary only and the disclosure is not limited thereto.

In addition, the secondary node addition request acknowledgement message may also include RRC configuration information used by the candidate target secondary node when the UE accesses to the candidate target secondary node.

At step 706, the candidate target master node sends a handover request acknowledgement message to the source master node. The handover request acknowledgement message may include indication information of an RRC configuration (RRC Config indication) used when the UE accesses to the candidate target master node and the candidate target secondary node, and RRC configuration information used when the UE accesses to the candidate target master node and the candidate target secondary node.

The candidate target master node may configure the RRC configuration information used when the UE accesses to the candidate target master node, based on the indication information in the received secondary node addition request acknowledgement message (from the T-SN) such that the RRC configuration type is consistent at both of the candidate target master node and the candidate target secondary node.

At step 707, the source master node sends an RRC reconfiguration message to the UE. The RRC reconfiguration message (which may also be referred to as a conditional handover configuration message) may include, but not limited to, trigger conditions for conditional handover, and RRC configuration information used when the UE accesses to the candidate target master node and the candidate target secondary node. The trigger conditions for conditional handover may be generated by the source master node for the candidate target master node and/or the candidate target secondary node. The RRC configuration information may be generated by each pair of candidate target master node and candidate target secondary node, respectively. In fact, the RRC reconfiguration message sent by the source master node to the UE includes the RRC configuration information of each pair of candidate target master and secondary nodes as well as the trigger condition for CHO.

At step 708, the UE sends an RRC reconfiguration complete message to the source master node to notify the source master node that the RRC configuration has been prepared.

At step 708a, the source master node sends an inter-network node user-plane address indication message (Xn-U Address Indication message) to the source secondary node.

At step 709, the source master node sends a new inter-node message (New Class2Msg) to the source secondary node.

The messages sent in step 708a or step 709 may include, but not limited to identification information indicating that conditional handover (CHO) has been triggered on the UE, and indication information of an RRC configuration used when the UE accesses to the candidate target master node and the candidate target secondary node. For example, the message sent in step 708a may include the identification information indicating that conditional handover (CHO) has been triggered on the UE, and the message sent in step 709 may include the indication information of the RRC configuration.

The above examples are only exemplary, and steps 708a and 709 may be emerged into one step, or the messages sent in steps 708a and 709 may each include different information as described above.

Next, the UE starts monitoring whether the trigger condition for conditional handover is satisfied while maintaining wireless connection to the source master node and the source secondary node.

During the conditional handover evaluation, the source secondary node may update a secondary cell group configuration without participation of the source master node. For example, the cases without the participation of the source master node may include a case in which the secondary cell group configuration is updated through a direct signaling connection between the source secondary node and the UE, thus the source master node cannot know whether the RRC configuration of the SCG is updated; or a case in which there is no direct signaling connection between the source secondary node and the UE (e.g., no SRB3), and the source secondary node passes the RRC message to the UE through the source master node, and the source master node only does the forwarding of the RRC message during the interaction of messages, but does not parse the contents thereof, thus there is no way to know whether the RRC configuration of the SCG is updated. The above example is only exemplary and the disclosure is not limited to it. In this case, if the RRC configuration type for the UE to access to the candidate target node is a delta configuration, the UE cannot configure delta messages based on the previously used RRC configuration information due to the update of the secondary cell group configuration (e.g. the master cell (PSCell) on the secondary cell group is changed). This results in a possible failure when the UE accesses to the target cell, leading to a failure of accessing to the radio link and thus affecting the user's service experience.

Considering that the delta configuration of the RRC configuration of the target cell is that delta messages need to be configured based on the radio resource control configuration information used when the UE receives the RRC reconfiguration message, the disclosure uses different methods to perform conditional handover according to the configuration type indicated by the indication information, to avoid the failure of accessing to the wireless link when the UE accesses to the target cell.

After sending the indication information to the source secondary node, such as after step 709, the source secondary node may use different methods to perform conditional handover depending on the value of the indication information of the radio resource control configuration.

As an example, when the value of the indication information of the radio resource control configuration is the delta configuration (delta config), the source secondary node may keep the master cell (PSCell) on the secondary cell group currently used by the UE unchanged, keep the radio resource control configuration used by the UE on the master cell (PSCell) as well as on the secondary cell (SCell) unchanged, and may not change the radio resource control configuration information for the UE. In this way, the UE may configure the delta messages based on the currently used radio resource control configuration information. The existing conditional handover process may be performed when the value of the indication information of the radio resource control configuration is a full configuration (full config).

As another example, at steps 710a to 710c, the source secondary node continues to perform update of the radio resource control configuration based on the wireless measurement report of the UE, including but not limited to changes to the secondary cell group configuration, updates to the radio resource control configuration of the current master cell (PSCell) on the source secondary node, changes to the current master cell (PSCell) on the source secondary node, and release of the current master cell (PSCell) on the source secondary node.

For example, the source secondary node continues to update the radio resource control configuration based on the wireless measurement report of the UE. At step 710a, the source secondary node sends an RRC reconfiguration message to the UE. At step 710b, the UE sends an RRC reconfiguration complete message to the source secondary node. At step 710c, a random access process is performed in the case where the current master cell (PSCell) on the source secondary node is changed.

At step 710d, the source secondary node may send a message to the source master node when the value of the indication information of the radio resource control configuration is the delta configuration (delta config). Here, the message may include, but not limited to, a secondary node modification required message. The secondary node modification required message may include, but not limited to, indication information that the radio resource control configuration of the UE on the source secondary node has been updated.

According to another example of the disclosure, at step 710d, the source secondary node may send a new message to the source master node when the value of the indication information of the radio resource control configuration is the delta configuration (delta config). The new message may include, but not limited to, indication information indicating that the radio resource control configuration of the UE on the source secondary node has been updated.

At step 710e, the source master node sends a message to the source secondary node. The message may include, but not limited to, a secondary node modification confirm message.

In the case of sending the new message at step 710d, step 710e may be omitted, i.e., the source master node no longer needs to respond with a reply to the secondary node modification required message.

In response to the secondary node modification confirm message or the new message, the user equipment and the source master node may take corresponding actions for subsequent processes. For example, the user equipment may cancel all prepared conditional handover configurations and the source master node sends a handover cancel message to all candidate target master nodes. In this case, the UE may not perform the conditional handover any longer.

For another example, the source master node sends a handover request message to all candidate target master nodes to update the existing conditional handover configuration (i.e. RRC configuration), and then the source master node updates the existing handover configuration message and sends it to the user equipment after receiving the handover request acknowledgement message from the candidate target master nodes. In this case, the UE may configure delta messages based on the updated conditional handover configuration to complete the conditional handover. That is, after the source master node receives the secondary node modification required message or the new message from the source secondary node, the update of the handover configuration may be performed again according to the steps 603 to 608 above, such that the UE may perform the conditional handover using the updated conditional handover configuration message and the delta configuration messages.

The above examples are only exemplary, and in the disclosure, the above steps may be performed when at least one set of delta configurations or no full configuration exists in the RRC configuration received by the UE.

At steps 711 to 713, the UE, after finding that at least one of trigger conditions for the conditional handover is satisfied, performs a random access on a candidate target master cell group (MCG) and a target secondary candidate cell group (SCG), attempts to establish a wireless connection from the UE to a master cell (PCell) on the candidate target MCG and a master cell (PSCell) on the candidate target SCG, and uses the radio resource control configuration used for accessing to the candidate target master node and the candidate target secondary node saved in the conditional handover configuration message. For example, at step 711, the UE performs a random access process with the candidate target master node by using the RRC configuration message saved in the conditional handover configuration message for accessing to the candidate target master node. At step 712, the UE sends an RRC reconfiguration complete message to the candidate target master node. At step 713, the UE performs a random access process with the candidate target secondary node by using the RRC configuration message saved in the conditional handover configuration message for accessing to the candidate target secondary node.

At step 714, the candidate target master node sends a secondary node reconfiguration complete message to the candidate target secondary node.

At step 715, the candidate target master node sends a handover success message to the source master node.

At steps 716 to 717, the source master node sends a handover cancel message to the relevant candidate target master node to release the relevant network resources.

Thus, a conditional handover method of the disclosure is completed. By the method, the network may be supported to configure conditional handover for the user equipment and complete the conditional handover smoothly to improve the probability of the user equipment of successfully accessing to the target network. The method allows the network device to flexibly exchange information between network device nodes according to the type of radio resource control configuration information when the user equipment accesses to the target network. In addition, the method enables the source network node to timely obtain the state changes on the UE side that may cause subsequent conditional handover access failure, and to perform necessary subsequent operations to reduce the probability of access failure.

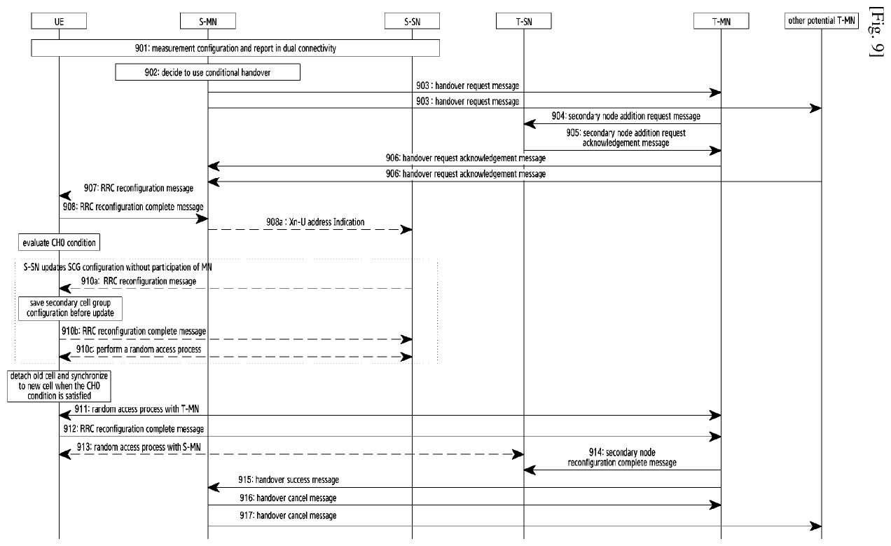

FIG. 8 is a flowchart of a UE performing conditional handover in a dual connectivity state according to another embodiment of the disclosure. FIG. 8 depicts a processing method for a candidate target secondary node (T-SN) to complete a conditional handover configuration while the UE is in a dual connectivity state. The conditional handover in the dual connectivity state is described in detail below using a 5G system as an example.

At step 801, a source master node (S-MN) and the source secondary node (S-SN) perform an interaction process of measurement configuration and measurement report while the UE is in the dual connectivity state.

At step 802, the source master node decides to enable the UE to perform conditional handover while the UE is in the dual connectivity state. The source master node decides to use the conditional handover.

At step 803, the source master node sends a handover request message to a plurality of candidate target master nodes. The handover request message may include, for example, a node identification of the UE at the source secondary node and a user identification of the user at the source secondary node, etc.

At step 804, for each candidate target master node, the candidate target master node sends a secondary node addition request message to a candidate target secondary node. In the 5G system, when a candidate target master node receives a conditional handover request, this candidate target master node sends a secondary node addition request message to the candidate target secondary node. The following is described as an example of a pair of candidate target master and secondary nodes, such as a target node to which the UE will be switched.

At step 805, the candidate target secondary node, after receiving the secondary node addition request message, checks whether a signaling connection (e.g. SRB3) exists between the user equipment and the source secondary node. If the signaling connection exists, a configuration type of a radio resource control configuration used by the candidate target secondary node when the user equipment accesses to the candidate target secondary node is determined to be a full configuration (full config). The candidate target secondary node sends to the candidate target master node a secondary node addition request acknowledgement message including indication information indicating the full configuration.

In the case where the RRC configuration is the full configuration, the execution of steps 806 to 817 may continue.

At step 806, the candidate target master node sends a handover request acknowledgement message to the source master node. The handover request acknowledgement message may include RRC configuration information used when the UE accesses to the candidate target master node and the candidate target secondary node.

At step 807, the source master node sends an RRC reconfiguration message to the UE. The RRC reconfiguration message may include, but not limited to, trigger conditions for conditional handover, and RRC configuration information used by the UE to access to the candidate target master node and the candidate target secondary node.

At step 808, the UE sends an RRC reconfiguration complete message to the source master node.

At step 808a, the source master node sends an inter-network node user-plane address indication message (Xn-U Address Indication message) to the source secondary node. Step 808a is optional and may be omitted in specific cases.

Next, the UE starts monitoring whether the trigger condition for conditional handover is satisfied while maintaining wireless connection to the source master node and the source secondary node.

At steps 810a to 810c, the source secondary node may continue to update the radio resource control configuration based on the wireless measurement report of the UE, including but not limited to, updates to the radio resource control configuration of the current master cell (PSCell) on the source secondary node, changes to the current master cell (PSCell) on the source secondary node, release of the current master cell (PSCell) on the source secondary node, and other changes to the secondary cell group configuration.

At steps 811 to 813, the user equipment, after finding that at least one of the trigger conditions for the conditional handover is satisfied, performs a random access on a candidate target master cell group (MCG) and a candidate target secondary cell group (SCG), attempts to establish a wireless connection from the UE to a master cell (PCell) on the candidate target MCG and a master cell (PSCell) on the candidate target SCG, and uses the radio resource control configuration used for accessing to the candidate target master node and the candidate target secondary node in the conditional handover configuration message.

At step 814, the candidate target master node sends a secondary node reconfiguration complete message to the candidate target secondary node.

At step 815, the candidate target master node sends a handover success message to the source master node.

At steps 816 to 817, the source master node sends a handover cancel message to the relevant candidate target master node to release the relevant network resources.

If the indication message sent by the candidate target secondary node at step 805 includes delta configuration information, the conditional handover may be performed in accordance with steps 706 to 710c in FIG. 7.

According to another embodiment of the disclosure, if there is a delta configuration type along with at least one full configuration type among the RRC configuration types saved by the UE, when the secondary cell group configuration on the source secondary node is changed, the UE may delete all the saved RRC configurations of the first configuration type and perform a conditional handover operation based on the RRC configuration of the at least one second configuration type.

As another example, if there is a delta configuration type along with at least one full configuration type among the configuration types saved by the UE, when the secondary cell group configuration on the source secondary node is changed, the UE may not evaluate the conditional handover condition corresponding to the delta configuration type, but only evaluate the conditional handover condition corresponding to the full configuration type, and notify the network that the secondary cell group configuration is changed and that the UE currently monitors only the conditional handover condition corresponding to the full configuration type.

As such, a conditional handover method of the disclosure is completed. By the method, the network may be supported to configure conditional handover for the user equipment and complete the conditional handover smoothly to improve the probability of the user equipment to successfully access to the target network. The method allows the target network node for the conditional handover to flexibly configure the type of the radio resource control configuration information used when the user equipment accesses to the target network node according to the state of the user equipment at the source network node, which can reduce the probability that the user equipment fails to access to the target network when performing the conditional handover.

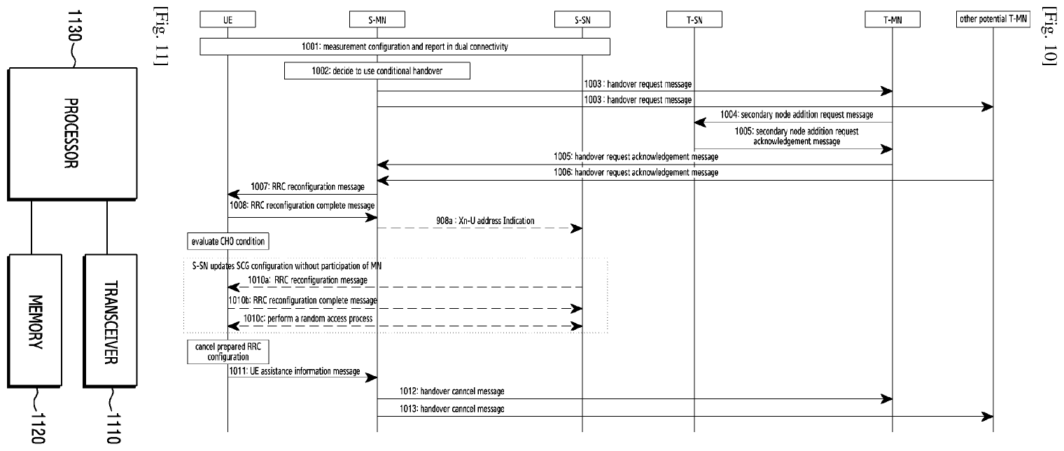

FIG. 9 is a flowchart of a UE performing conditional handover in a dual connectivity state according to an embodiment of the disclosure. FIG. 9 depicts a processing method for the UE to complete a conditional handover configuration in the dual connectivity state. The conditional handover in the dual connectivity state is described in detail below using a 5G system as an example.

At step 901, a source master node (S-MN) and a source secondary node (S-SN) perform an interaction process of measurement configuration and measurement report while the UE is in the dual connectivity state.

At step 902, the source master node decides to enable the UE to perform conditional handover while the UE is in the dual connectivity state. The source master node decides to use the conditional handover.

At step 903, the source master node sends a handover request message to a plurality of candidate target master nodes. The handover request message may include, for example, a node identification of the UE at the source secondary node and a user identification of the user at the source secondary node, etc.

At step 904, for each candidate target master node, the candidate target master node sends a secondary node addition request message to a candidate target secondary node. In the 5G system, when a candidate target master node receives a handover request message, this candidate target master node sends a secondary node addition request message to the candidate target secondary node. The following is described as an example of a pair of candidate target master and secondary nodes (such as a target node to which the UE will be switched).

At step 905, the candidate target secondary node sends a secondary node addition request acknowledgement message to the candidate target master node. The secondary node addition request acknowledgement message may include indication information of a Radio Resource Control (RRC) configuration used by the corresponding candidate target secondary node when the UE accesses to the candidate target secondary node. The indication information may be used to indicate an RRC configuration type. In addition, the secondary node addition request acknowledgement message may also include RRC configuration information used by the candidate target secondary node when the UE accesses to the candidate target secondary node. In general, the configuration types of the RRC configurations generated by the candidate target master node and the corresponding candidate target secondary node are the same.

At step 906, the candidate target master node sends a handover request acknowledgement message to the source master node. The handover request acknowledgement message may include, but not limited to, RRC configuration information used when the UE accesses to the candidate target master node and RRC configuration information used when the UE accesses to the candidate target secondary node.

At step 907, the source master node sends an RRC reconfiguration message to the UE. The RRC reconfiguration message may include, but not limited to, trigger conditions for conditional handover, RRC configuration information used by the UE to access to the candidate target master node and the candidate target secondary node.

At step 908, the UE sends an RRC reconfiguration complete message to the source master node.

At step 908a, the source master node sends an inter-network node user-plane address indication message (Xn-U Address Indication message) to the source secondary node. Step 908a is optional and may be omitted in specific cases.

Next, the UE starts monitoring whether the trigger condition for conditional handover is satisfied while maintaining wireless connection to the source master node and the source secondary node.

During the conditional handover evaluation, the source secondary node may update a secondary cell group (SCG) configuration without participation of the source master node. In this case, if the RRC configuration type of the UE to access to the candidate target node is a delta configuration, the UE cannot configure the delta messages based on the previously used RRC configuration message due to the update of the secondary cell group configuration (e.g. change of the master cell (PSCell) on the secondary cell group). This results in a possible failure when the UE accesses to the target cell, leading to a failure of accessing to the radio link and thus affecting the user's service experience.

This disclosure considers that the delta configuration of the RRC configuration of the target cell is that delta messages need to be configured based on the radio resource control configuration information (RRC Configuration) used when the UE receives the RRC reconfiguration message, which may also be called the conditional handover configuration message, thus the conditional handover may be performed according to the RRC configuration type to avoid the failure of accessing to the wireless link when the UE accesses to the target cell.

The source secondary node may continue to update the radio resource control configuration based on the wireless measurement report of the UE. At step 910a, the source secondary node sends an RRC reconfiguration message to the UE.

After step 910a, the UE may determine whether the saved at least one RRC configuration is a delta configuration, and when the configuration type of the radio resource control configuration used when the user equipment accesses to the candidate target master node and the candidate target secondary node in the at least one RRC configuration is the delta configuration, the UE may save the radio resource control configuration of the secondary cell group (SCG) used before the update. The UE may save the radio resource control configuration of the SCG used before the update. For example, when updating the radio resource control configuration on the PSCell, the UE may save the radio resource control configuration used before the update, e.g. the secondary cell group configuration on the source secondary node.

At step 910b, the UE sends an RRC reconfiguration complete message to the source secondary node.

At step 910c, a random access process is performed when, for example, the current master cell (PSCell) on the source secondary node is changed.

In the disclosure, the source secondary node may update the radio resource control configuration on the PSCell normally, but the UE needs to save the radio resource control configuration used before the update.

At steps 911 and 912, the user equipment performs a random access on a candidate target master cell group (MCG) after finding that at least one of the trigger conditions for conditional handover is satisfied, attempts to establish a wireless connection from the UE to a master cell (PCell) on the candidate target MCG, and uses the radio resource control configuration information used when accessing to the candidate target master node in the RRC reconfiguration message.

At step 913, a random access is performed on a candidate target secondary cell group (SCG) to try to establish a wireless connection from the UE to a master cell (PSCell) on a candidate target SCG, and the conditional handover is performed using the radio resource control configuration used before the secondary cell group configuration is updated. For example, the UE configures the delta messages based on the radio resource control configuration used before the PSCell is updated.

At step 914, the candidate target master node sends a secondary node reconfiguration complete message to the candidate target secondary node.

At step 915, the candidate target master node sends a handover success message to the source master node.

At steps 916 to 917, the source master node sends a handover cancel message to the relevant candidate target master node to release the relevant network resources.

As such, a conditional handover method of the disclosure is completed. By the method, the user equipment may receive the information related to the conditional handover configured by the network and smoothly complete the conditional handover when the condition is satisfied, improving the probability of the user equipment to successfully access to the target network. The method does not require additional signaling between the network nodes, and the user equipment may flexibly operate according to the type of the radio resource control configuration information used when accessing to the target network node, reducing the probability that the user equipment fails to access to the target network when performing the conditional handover.

FIG. 10 is a flowchart of a UE performing conditional handover in a dual connectivity state according to another embodiment of the disclosure. FIG. 10 depicts a processing method for completing a conditional handover configuration between the UE and a network device in the dual connectivity state. The conditional handover in the dual connectivity state is described in detail below using a 5G system as an example.

At step 1001, a source master node (S-MN) and a source secondary node (S-SN) perform an interaction process of measurement configuration and measurement report while the UE is in the dual connectivity state.

At step 1002, the source master node decides to enable the UE to perform conditional handover while the UE is in the dual connectivity state. The source master node decides to use the conditional handover.

At step 1003, the source master node sends a handover request message to a plurality of candidate target master nodes. The handover request message may include, for example, a node identification of the UE at the source secondary node and a user identification of the user at the source secondary node, etc.

At step 1004, for each candidate target master node, the candidate target master node sends a secondary node addition request message to a candidate target secondary node. In the 5G system, when a candidate target master node receives a conditional handover request, this candidate target master node sends a secondary node addition request message to the candidate target secondary node. The following is described as an example of a pair of candidate target master and secondary nodes, such as a target node to which the UE will be switched.

At step 1005, the candidate target secondary node sends a secondary node addition request acknowledgement message to the candidate target master node. The secondary node addition request acknowledgement message may include indication information (RRC Config indication) of a Radio Resource Control (RRC) configuration used by the corresponding candidate target secondary node when the UE accesses to the candidate target secondary node. This indication information may be used by the corresponding candidate target master node to generate RRC configuration information of the same configuration type.

In addition, the secondary node addition request acknowledgement message may also include RRC configuration information used by the candidate target secondary node when the UE accesses to the candidate target secondary node.

At step 1006, the candidate target master node sends a handover request acknowledgement message to the source master node. The handover request acknowledgement message may include, but not limited to, RRC configuration information used by the corresponding candidate target secondary node when the UE accesses to the candidate target secondary node, and RRC configuration information used by the candidate target master node when the UE accesses to the candidate target master node. Here, the RRC configuration information used by the candidate target master node when the UE accesses to the candidate target master node may be generated based on the indication information received in step 1005. That is, the candidate target master node may configure the RRC configuration information used when the UE accesses to the candidate target master node based on the indication information in the secondary node addition request acknowledgement message after receiving the secondary node addition request acknowledgement message, such that the RRC configuration type is consistent at the candidate target master node and the candidate target secondary node.

At step 1007, the source master node sends an RRC reconfiguration message to the UE. The RRC reconfiguration message may include, but not limited to, trigger conditions for conditional handover, and RRC configuration information used by the UE to access to the candidate target master node and the candidate target secondary node.

At step 1008, the UE sends an RRC reconfiguration complete message to the source master node.

At step 1008a, the source master node sends an inter-network node user-plane address indication message (Xn-U Address Indication message) to the source secondary node. Step 1008a is optional and may be omitted in specific cases.

Next, the UE starts monitoring whether the trigger condition for conditional handover is satisfied while maintaining wireless connection to the source master node and the source secondary node.

During the conditional handover evaluation, the source secondary node may update the secondary cell group SCG configuration without the involvement of the source master node. In this case, if the RRC configuration type of the UE to access to the candidate target node is a delta configuration, the UE cannot configure the delta messages based on the previously used RRC configuration message due to the update of the secondary cell group configuration (e.g. change of the master cell (PSCell) on the secondary cell group). This results in a possible failure when the UE accesses to the target cell, leading to a failure of accessing to the radio link and thus affecting the user's service experience.

This disclosure considers that the delta configuration of the RRC configuration of the target cell is that delta messages need to be configured based on the radio resource control configuration information (RRC Configuration) used when the UE receives the RRC reconfiguration message, which may also be called the conditional handover configuration message, thus the conditional handover is performed according to the RRC configuration type to avoid the failure of accessing to the wireless link when the UE accesses to the target cell.

During the conditional handover evaluation, the source secondary node may continue to update the radio resource control configuration based on the wireless measurement report of the UE.

For example, at step 1010a, the source secondary node sends an RRC reconfiguration message to the UE. At step 1010b, the UE sends an RRC reconfiguration complete message to the source secondary node. The master cell (PSCell) on the source secondary node is changed. At step 1010c, a random access process is performed when the current master cell (PSCell) on the source secondary node is changed.

After step 1010a, the UE may determine the configuration types of one or more saved RRC configurations. For example, after the UE receives the RRC reconfiguration message, it may determine the configuration type of the RRC configuration information received in step 1007.

At step 1011, when at least one RRC configuration used when the UE accesses to the candidate target master node and the candidate target secondary node among the received RRC configurations is the delta configuration (delta config), the UE may cancel all prepared RRC configurations and the UE sends a UE assistance information message to the source master node. The UE assistance information message may include, but not limited to, an instruction about that the radio resource control configuration of the PSCell is updated and/or information about that the prepared CHO configuration has been cancelled by the UE.

In addition, the UE may determine the configuration type of the RRC configuration information after step 1010c, cancel the RRC configuration configured in step 1007 if a delta configuration exists, and send the UE assistance information message to the source master node. The above examples are only exemplary and the order of the above steps may be set differently depending on the design requirements. Alternatively, the configuration type of the RRC configuration information may be determined after step 1010a, and if the delta configuration type exists, the RRC configuration prepared for conditional handover may be cancelled, and the UE assistance information message is sent to the source master node after the random access process is completed at step 1010c.

At steps 1012 to 1013, in response to receiving the UE assistance information message, the source master node sends a handover cancel message to all candidate target master nodes to release the relevant network resources.

According to another embodiment, in response to receiving the UE assistance information message, the source master node may send a handover request message to all candidate target master nodes to obtain a new RRC reconfiguration message.

When at least one RRC configuration used when the UE accesses to the candidate target master node and the candidate target secondary node among the received RRC configurations is the full configuration (full config), the UE may perform conditional handover with the candidate target master node and the candidate target secondary node corresponding to the full configuration.

As an example, if there is a delta configuration type along with at least one full configuration type among the configuration types saved by the UE, when the secondary cell group configuration on the source secondary node is changed, the UE may delete all the saved RRC configurations of the first configuration type, and perform a conditional handover operation based on the RRC configuration of the at least one second configuration type.

As another example, if there is a delta configuration type along with at least one full configuration type among the configuration types saved by the UE, when the secondary cell group configuration on the source secondary node is changed, the UE may not evaluate the conditional handover condition corresponding to the delta configuration type and only evaluate the conditional handover condition corresponding to the full configuration type, and notify the network that the secondary cell group configuration is changed and that the UE currently monitors only the conditional handover condition corresponding to the full configuration type.

For example, when there is a delta configuration along with at least one full configuration among the RRC configurations saved by the UE, after the SCG configuration is changed, the UE may delete all the saved delta configurations, or the UE may no longer evaluate the conditional handover condition corresponding to the delta configuration, but only monitor the conditional handover condition corresponding to the full configuration, and notify the network that the SCG configuration has been changed and that the UE currently monitors only the conditional handover condition of the full configuration.

As such, a conditional handover method of the disclosure is completed. By the method, the user equipment may receive the information related to the conditional handover configured by the network and flexibly operate according to the type of the radio resource control configuration information used when accessing to the target network node. The method does not require additional signaling between the network nodes and can reduce the probability that the user equipment fails to access to the target network when performing the conditional handover.

FIG. 11 illustrates a block diagram of a user equipment (UE) in a communication system provided by an embodiment of the application. Referring to FIG. 11, the UE according to an embodiment may include a transceiver 1110, a memory 1120, and a processor 1130. The transceiver 1110, the memory 1120, and the processor 1130 of the UE may operate according to a communication method of the UE described above. However, the components of the UE are not limited thereto. For example, the UE may include more or fewer components than those described above. In addition, the processor 1130, the transceiver 1110, and the memory 1120 may be implemented as a single chip. Also, the processor 1130 may include at least one processor. Furthermore, the UE of FIG. 11 corresponds to the UE 116 of the FIG. 3A.

The transceiver 1110 collectively refers to a UE receiver and a UE transmitter, and may transmit/receive a signal to/from a base station or a network entity. The signal transmitted or received to or from the base station or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the UE. Also, the memory 1120 may store control information or data included in a signal obtained by the UE. The memory 1120 may be a storage medium, such as read-only memory (ROM), random access memory (RAM), a hard disk, a CD-ROM, and a DVD, or a combination of storage media.

The processor 1130 may control a series of processes such that the UE operates as described above. For example, the transceiver 1110 may receive a data signal including a control signal transmitted by the base station or the network entity, and the processor 1130 may determine a result of receiving the control signal and the data signal transmitted by the base station or the network entity. the processor 1130 is coupled with the transceiver 1110 and is configured to determine a configuration type of an RRC configuration corresponding to a candidate target master node and a candidate target secondary node, and perform a conditional handover operation according to the configuration type of the RRC configuration corresponding to the candidate target master node and the candidate target secondary node.

The operational details of the method performed by the UE described above may refer to the descriptions of FIGS. 4 to 10, all of which are not repeated here.

FIG. 12 illustrates a block diagram of a node device in a communication system provided by an embodiment of the application. Referring to FIG. 12, the base station according to an embodiment may include a transceiver 1210, a memory 1220, and a processor 1230. The transceiver 1210, the memory 1220, and the processor 1230 of the base station may operate according to a communication method of the base station described above. However, the components of the base station are not limited thereto. For example, the base station may include more or fewer components than those described above. In addition, the processor 1230, the transceiver 1210, and the memory 1220 may be implemented as a single chip. Also, the processor 1230 may include at least one processor. Furthermore, the base station of FIG. 12 corresponds to the gNB 102 of the FIG. 3B.

The transceiver 1210 collectively refers to a base station receiver and a base station transmitter, and may transmit/receive a signal to/from a terminal (UE) or a network entity. The signal transmitted or received to or from the terminal or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the base station. Also, the memory 1220 may store control information or data included in a signal obtained by the base station. The memory 1220 may be a storage medium, such as read-only memory (ROM), random access memory (RAM), a hard disk, a CDROM, and a DVD, or a combination of storage media.

The processor 1230 may control a series of processes such that the base station operates as described above. For example, the transceiver 1210 may receive a data signal including a control signal transmitted by the terminal, and the processor 1230 may determine a result of receiving the control signal and the data signal transmitted by the terminal. the processor 1230 is coupled with the transceiver 1210 and is configured to transmit a first message to at least one candidate target master node respectively, receive, from the candidate target master node, a second message that responds to the first message, wherein the second message includes information of an RRC configuration indication corresponding to the candidate target master node and a candidate target secondary node, and transmit a third message including the information of the RRC configuration indication to a source secondary node. Alternatively, the processor 1230 may be configured to receive a third message from a source master node, wherein the third message includes information of an RRC configuration indication corresponding to a candidate target master node and a candidate target secondary node.

The operational details of the method performed by the node described above may refer to the descriptions of FIGS. 4 through 10, all of which are not repeated here.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

According to the embodiments of the disclosure, an electronic device is further provided, including: at least one processor; and at least one memory storing computer executable instructions, wherein the computer-executable instructions, when run by the at least one processor, cause the at least one processor to perform any one of the methods as described above.

As an example, the electronic device may be a PC computer, a tablet device, a personal digital assistant, a smartphone, or any other device capable of executing the above instruction set. Here, the electronic device does not have to be a single electronic device, but may also be any set of devices or circuits capable of executing the above instructions (or instruction set) individually or jointly. The electronic device may also be a part of an integrated control system or system manager, or may be configured as a portable electronic device that interfaces locally or remotely (e.g., via wireless transmission).

In the electronic device, the processor may include a central processing unit (CPU), graphics processing unit (GPU), programmable logic device, special purpose processor system, microcontroller or microprocessor. By way of example and not limitation, the processor may also include analog processors, digital processors, microprocessors, multi-core processors, processor arrays, network processors, and the like.

The processor may execute instructions or code stored in the memory, which may also store data. Instructions and data may also be sent and received over a network via a network interface, which may employ any known transport protocol.

The memory may be integrated with the processor, e.g., an RAM or flash memory is arranged within an integrated circuit microprocessor or the like. Additionally, the memory may include a separate device such as an external disk drive, storage array, or any other storage device that may be used by a database system. The memory and the processor may be operatively coupled, or may communicate with each other, e.g., through I/O ports, network connections, etc., to enable the processor to read files stored in the memory.

In addition, the electronic device may also include video displays (e.g. liquid crystal display) and user interaction interfaces (e.g. keyboard, mouse, touch input device, etc.). All components of the electronic device may be connected to each other via a bus and/or a network.

According to an embodiment of the disclosure, a computer readable storage medium storing instructions is also provided. The instructions, when executed by at least one processor, causes the at least one processor to perform any of the above methods according to the exemplary embodiments of the disclosure. Examples of computer readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device, such as client, host, proxy device, server, etc. In addition, in one example, the computer programs and any associated data, data files, and data structures are distributed on a networked computer system, so that the computer programs and any associated data, data files, and data structures are stored, accessed and executed through one or more processors or computers in a distributed manner.

It should be noted that the terms “first”, “second”, “third”, “fourth”, “1”, “2”, etc. (if present) used in the specification and claims and the accompanying drawings above of the application are used to distinguish similar objects and are not necessary for describing a particular order or sequence. It should be understood that the data so used is interchangeable in appropriate cases so that the embodiments of the application described herein may be implemented in an order other than that illustrated or described herein.

It should be understood that while the flowcharts of the embodiments of the application indicate the individual operational steps by arrows, the order of these implementation steps is not limited to the order indicated by the arrows. Unless explicitly stated herein, in some implementation scenarios of the embodiments of the application, the implementation steps in the respective flowcharts may be performed in other orders as desired. In addition, some or all of the steps in each flowchart may include multiple sub-steps or multiple stages based on actual implementation scenarios. Some or all of these sub-steps or stages may be executed at the same moment, and each of these substeps or stages may also be executed separately at different moments. In the scenarios where the execution moments are different, the order of execution of these sub-steps or stages may be flexibly configured according to the needs, and the embodiments of the application are not limited thereto.

The above description is only an optional implementation of part of the implementation scenarios of the application. It should be noted that for those ordinary skill in the art, other similar means of implementation based on the technical idea of the application, without departing from the technical idea of the application, also fall within the scope of protection of the embodiments of the application.

Other embodiments of the disclosure will readily be conceived by those skill in the art after considering the specification and practicing the invention disclosed herein. The application is intended to cover any variation, use, or adaptation of the disclosure that follows the general principle of the disclosure and includes commonly known or customary technical means in the art not disclosed herein. The specification and embodiments are to be considered exemplary only, and the true scope and spirit of the disclosure is limited by the claims.

While the disclosure has been shown and described with reference to various embodiments thereof, it will be understood by those skilled in the art that various changes in form and details may be made therein without departing from the spirit and scope of the disclosure as defined by the appended claims and their equivalents.

1-15. (canceled)

16. A method performed by a source node in a wireless communication system, the method comprising:
transmitting, to a target node via an Xn interface, a first message for requesting a conditional handover (CHO); and
receiving, from the target node via the Xn interface, a second message in response to the first message, wherein the second message includes information indicating a type of a radio resource control (RRC) configuration associated with the source node.

17. The method of claim 16,
wherein the type of the RRC configuration includes a full configuration or a delta configuration.

18. The method of claim 16,
wherein the RRC configuration is for the CHO in a dual connectivity.

19. The method of claim 16,
wherein the source node includes a source master node.

20. The method of claim 16,
wherein the target node includes at least one candidate target master node.

21. A method performed by a target node in a wireless communication system, the method comprising:
receiving, from a source node via an Xn interface, a first message for requesting a conditional handover (CHO); and
transmitting, to the source node via the Xn interface, a second message in response to the first message, wherein the second message includes information indicating a type of a radio resource control (RRC) configuration associated with the source node.

22. The method of claim 21,
wherein the type of the RRC configuration includes a full configuration or a delta configuration.

23. The method of claim 21,
wherein the RRC configuration is for the CHO in a dual connectivity.

24. The method of claim 21,
wherein the source node includes a source master node.

25. The method of claim 21,
wherein the target node includes at least one candidate target master node.

26. A source node in a wireless communication system, the source node comprising:
a transceiver; and
at least one processor coupled with the transceiver and configured to:
transmit, to a target node via an Xn interface, a first message for requesting a conditional handover (CHO), and
receive, from the target node via the Xn interface, a second message in response to the first message, wherein the second message includes information indicating a type of a radio resource control (RRC) configuration associated with the source node.

27. The source node of claim 26,
wherein the type of the RRC configuration includes a full configuration or a delta configuration.

28. The source node of claim 26,
wherein the RRC configuration is for the CHO in a dual connectivity.

29. The source node of claim 26,
wherein the source node includes a source master node.

30. The source node of claim 26,
wherein the target node includes at least one candidate target master node.

31. A target node in a wireless communication system, the target node comprising:
a transceiver; and
at least one processor coupled with the transceiver and configured to:
receive, from a source node via an Xn interface, a first message for requesting a conditional handover (CHO), and
transmit, to the source node via the Xn interface, a second message in response to the first message, wherein the second message includes information indicating a type of a radio resource control (RRC) configuration associated with the source node.

32. The target node of claim 31,
wherein the type of the RRC configuration includes a full configuration or a delta configuration.

33. The target node of claim 31,
wherein the RRC configuration is for the CHO in a dual connectivity.

34. The target node of claim 31.
wherein the source node includes a source master node.

35. The target node of claim 31.
wherein the target node includes at least one candidate target master node.
